(19) United States
(12) Patent Application Publication
(10) Pub. No.: US 2011/0193702 A1
(43) Pub. Date: Aug. 11, 2011

(54) WIRELESS APPARATUSES, SYSTEMS, AND METHODS FOR LOCATING ITEMS

(76) Inventors: William Mathews BROOKS, Fremont, CA (US); Mason Freed, Pleasant Hill, CA (US)

(21) Appl. No.: 12/843,021

(22) Filed: Jul. 24, 2010

Related U.S. Application Data
(60) Provisional application No. 61/302,086, filed on Feb. 5, 2010.

(51) Int. Cl. G08B 13/14

(52) U.S. Cl. 340/572.7; 340/572.1

(57) ABSTRACT

Presented are wireless apparatuses, systems, and methods for locating items. According to one embodiment, the apparatus includes a sensor module and an indicator module capable of wireless communication.

### CROSS-REFERENCE TO RELATED APPLICATIONS

The present application claims benefit of U.S. Provisional Patent Application Ser. No. 61/302,086, filed 2 Feb. 2010, inventors Brooks and Freed. The present application is related to U.S. Provisional Patent Application Ser. No. 61/302,086, filed 2 Feb. 2010. The contents of all of these applications are incorporated herein in their entirety by this reference for all purposes.

### BACKGROUND

A variety of practices and technologies are available for dealing with the dangers of avalanches such as snow avalanches. In particular, the task of locating and rescuing avalanche victims is the focus of many of the current practices and technologies. Although some of the current practices and technologies provide satisfactory results, the present inventors have recognized that improved practices and technologies may yield increases in the success rates for rescuing avalanche victims. More specifically, the present inventors have recognized there is a need for improved methods and/or apparatuses that can be used for avalanche victim rescues.

### SUMMARY

This invention pertains to wireless apparatuses, systems, and methods for locating items. One aspect of the invention includes an apparatus. According to one embodiment, the apparatus comprises a sensor module comprising an information processor, a radio frequency receiver, and a wireless transmitter receiver for wireless communication. The embodiment also includes a pole attached to the sensor module. According to another embodiment, the apparatus comprises a sensor module comprising a first information processor, a radio frequency receiver, and a first wireless transmitter receiver for communication and an indicator module comprising a second information processor, a second wireless transmitter-receiver for wireless communication so that the sensor module and the indicator module can communicate wirelessly.

Another aspect of the present invention includes one or more methods of locating signal beacons for avalanche victims.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

The above and still further features and advantages of the present invention will become apparent upon consideration of the following detailed descriptions of specific embodiments thereof, especially when taken in conjunction with the accompanying drawings.

### BRIEF DESCRIPTION OF DRAWINGS

FIG. 1 is a block diagram of an embodiment of the present invention.

FIG. 2 is a diagram of an embodiment of the present invention.

FIG. 3 is a diagram of an embodiment of the present invention.

FIG. 4 is a diagram of an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

For the following defined terms, these definitions shall be applied, unless a different definition is given elsewhere in this specification. All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

Embodiments of the present invention will be discussed below primarily in the context of locating and rescuing snow avalanche victims. However, it is to be understood that embodiments in accordance with the present invention may be used for other activities involving locating items or people in situations other than in snow.

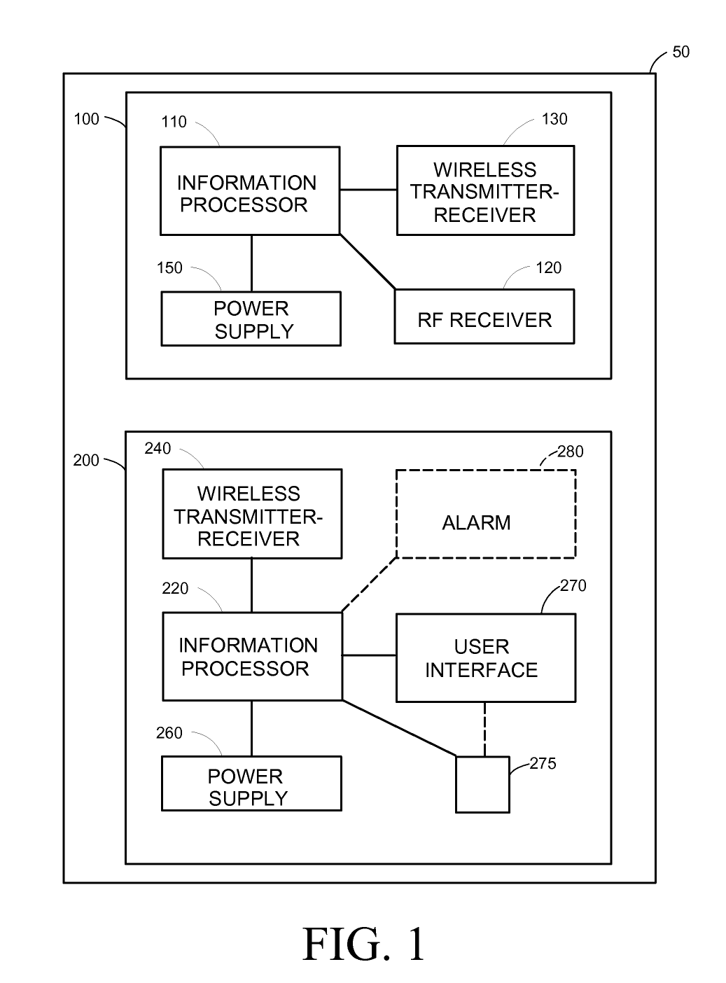

Reference is now made to FIG. 1 where there is shown a block diagram according to one embodiment of the present invention. FIG. 1 shows a combination 50 comprising a sensor module 100 and an indicator module 200. Sensor module 100 comprises a first information processor 110, a radio frequency (RF) receiver 120, a first wireless transmitter-receiver 130, and a first electrical power supply 150 for powering sensor module 100. FIG. 1 also shows indicator module 200 comprises a second information processor 220, a second wireless transmitter-receiver 240, a second electrical power supply 260 for powering the indicator module 200, a user interface 270, a mechanical switch 275 connected with information processor 220 and optionally connected with user interface 270. As an option, indicator module 200 further comprises one or more alarms 280, shown in broken lines.

Information processor 110 may be one of a variety of information processors that are commercially available. Information processor 220, optionally, may be substantially the same in terms of characteristics and capabilities as information processor 110. Information processor 110 and/or information processor 220 comprise a computer, a microprocessor, an application specific integrated circuit, programmable gate array, or other device capable of processing information and performing computer executable instructions. Information processor 110 may include one or more data input connections and one or more data output connections. Information processor 110 and/or information processor 220 may include a memory device or may work in conjunction with a memory device. Information processor 110 and/or information processor 220 is capable of storing and/or executing computer executable instructions. Optionally the computer executable instructions may be written in a computer programming language, such as assembly language, such as a machine language, such as C, such as C++, and such as BASIC. Optionally, the software may be broken up into multiple files for easier readability. The software may employ subroutines for performing particular actions and commands.

Specific software commands and structures may be dependent upon the particular hardware configuration that will use the software. In other words, the operational capabilities of information processor 110 may be dependent upon the computer processing power of the hardware of information processor 110 and the additional capabilities that result from the software and software instructions that are executed by information processor 110. Similarly, the operational capabilities of information processor 220 may be dependent upon the computer processing power of the hardware of information processor 220 and the additional capabilities that result from the software and software instructions that are executed by information processor 220. In the spirit of providing a general description of the software, the following description emphasizes features for one or more exemplary embodiments of the present invention. Obvious hardware dependent generalities may not be described here unless necessary. In addition, details may not be given for well-known support algorithms such as error handling, device initialization, peripheral drivers, information transfer, timer control, and other general types of command execution.

According to one embodiment of the present invention, RF receiver 120 is responsive to radio frequency signals from a beacon such as beacons used for the rescue of the snow avalanche victims. The beacons are designed to emit a radio frequency signal in the event that the person carrying the beacon is buried in a snow avalanche. RF receiver 120 is connected with first information processor 110 and is capable of providing input information to first information processor 110. First information processor 110 is capable of receiving input information from RF receiver 120 and deriving location information such as proximity information and/or direction information for the beacon using the input information from RF receiver 120. First information processor 110 is capable of outputting the location information to first wireless transmitter-receiver 130 for wireless transmission of the information to second wireless transmitter-receiver 240. Second wireless transmitter-receiver 240 is connected with information processor 220 and is capable of outputting the wirelessly transmitted proximity information and/or direction information to second information processor 220. Second information processor 220 is connected with a user interface 270 and optionally connected with one or more alarms 280. Information processor 220 is capable of providing the proximity information and/or direction information for the beacon to user interface 270 and/or the one or more alarms 280.

According to an alternative embodiment, RF receiver 120 is responsive to radio frequency signals from a beacon as described supra. RF receiver 120 is connected with first information processor 110 and is capable of providing input information to first information processor 110. First information processor 110 is connected with wireless transmitter receiver 130 and is capable of outputting the input information from RF receiver 120 to first wireless transmitter-receiver 130 for wireless transmission to second wireless transmitter receiver 240. Optionally, first information processor 110 may be capable of modifying the information from RF receiver 120. Second wireless transmitter-receiver 240 is connected with second information processor 220 and is capable of outputting the wirelessly transmitted information to second information processor 220. Second information processor 220 is capable of deriving location information such as proximity information and/or direction information for the beacon using the information for the signals from the beacon. Second information processor 220 is connected with a user interface 270 and optionally connected with one or more alarms 280. Information processor 220 is capable of providing the proximity information and/or direction information for the beacon to user interface 270 and/or the one or more alarms 280.

The information transferred between sensor module 100 and indicator module 200 may also include information such as, but not limited to, instructions for operation such as on-off commands, signal information picked up by RF receiver 120, state of readiness for operation, identification information, battery state of charge information, and other information.

According to one embodiment of the present invention, RF receiver 120 comprises a substantially unsophisticated amplitude-modulation receiver circuit to detect the radio frequency signals from the beacon. For some embodiments of the present invention, RF receiver 120 substantially does not include the capability of wireless transmission. An example of a suitable amplitude modulation receiver for one or more embodiments of the present invention includes, but is not limited to a Philips/NXP TEA5777. Also according to one embodiment of the present invention, RF receiver 120 comprises a ferrite bar antenna for picking up the radio frequency signals from the beacon. The present inventors have found that the combination of a substantially unsophisticated amplitude modulation receiver circuit and a ferrite bar antenna provides satisfactory results for the operation of sensor modules according to one or more embodiments of the present invention. Optionally, RF receiver 120 comprises one or more antennas.

Some beacons used for snow avalanche situations broadcast at a frequency of about 457 kilo Hertz (kHz). One or more embodiments of the present invention use RF receiver 120 configured to pick up signals of about 457 kHz. It is to be understood that RF receiver 120 can be configured to pick up other frequencies for other types of beacons.

Wireless transmitter receiver 130 is capable of transmitting and receiving a signal in the general radio frequency spectrum. Optionally, first wireless transmitter receiver 130 comprises one or more antennas. Wireless transmitter receiver 240, optionally, may be substantially the same in terms of characteristics and capabilities as wireless transmitter receiver 130. A variety of frequencies may be used for the operation of wireless transmitter receiver 130 and/or wireless transmitter receiver 240. The present inventors have discovered that operating wireless transmitter receiver 130 and wireless transmitter receiver 240 at a frequency of about 2.4 giga Hertz (GHz) provides satisfactory results for one or more embodiments of the present invention.

Remarkably, the operation of one or more embodiments of the present invention at communication frequencies of about 2.4 GHz is effective even for transmissions through snow that occur when sensor module 100 is disposed beneath a layer of snow and indicator module 200 is disposed above the snow. Since snow is typically a mixture of ice, liquid water, and air, the present inventors were surprised by the unexpected results of getting good signal transmissions when one or more embodiments of the present invention use wireless transmitter receiver 130 and wireless transmitter receiver 240 configured to transmit and receive wireless signals at 2.4 GHz. In other words, the present inventors have observed effective transmission signals at 2.4 GHz through snow even though 2.4 GHz signals are strongly attenuated by water.

Power supply 150 shown for sensor module 100 may comprise one or more electrical connectors for connecting to an electrical power source such as one or more batteries and such as one or more capacitors and/or power supply 150 includes an electrical power source such as one or more batteries and such as one or more capacitors. In other words power supply 150 represents either hardware for making electrical connections to a power source and/or power supply 150 comprises a power source. Power supply 150 is connected with information processor 110 to provide information processor 110 with electrical power for operation. Information processor 110 is also connected with wireless transmitter receiver 130 and RF receiver 120 to provide electrical power from power supply 150 for the operation of wireless transmitter receiver 130 and RF receiver 120. In other words, the configuration of sensor module 100 shown in FIG. 1 has information processor 110 configured to control the electrical power for operating wireless transmitter 130 and RF receiver 120. Optionally, information processor 110 may use one or more computer programs or subroutines to control the electrical power applied to wireless transmitter receiver 130 and RF receiver 120 according to one or more instructions.

Power supply 260 shown for sensor module 200 may comprise one or more electrical connectors for connecting to an electrical power source such as one or more batteries and such as one or more capacitors and/or power supply 260 includes an electrical power source such as one or more batteries and such as one or more capacitors. In other words, power supply 260 represents either hardware for making electrical connections to a power source and/or power supply 260 comprises a power source. Power supply 260 is connected with second information processor 220 to provide second information processor 220 with electrical power for operation of second information processor 220 and electrical power to be distributed to second wireless transmitter receiver 240, user interface 270, and if present, the one or more alarms 280. Mechanical switch 275 is capable of providing a digital input to second information processor 220 to cause second information processor 220 to start or to terminate reduced power consumption conditions in which other circuits are powered down. In other words, second information processor 220 puts itself in or removes itself from a very low current state in response to inputs from mechanical switch 275. Optionally, the control of mechanical switch 275 may be exercised by a user through user interface 270 as shown in FIG. 1, or mechanical switch 275 may be arranged to be operated by a user independently of user interface 270.

Information processor 220 is also connected with wireless transmitter receiver 240 and user interface 270 to provide electrical power from power supply 260 for the operation of wireless transmitter receiver 240 and user interface 270. In other words, the configuration of sensor module 200 shown in FIG. 1 has information processor 220 configured to control the electrical power for operating wireless transmitter 240 and user interface 270. Optionally, information processor 220 may use one or more computer programs or subroutines to control the electrical power applied to wireless transmitter receiver 240 and user interface 270 according to one or more instructions.

According to one or more embodiments of the present invention, mechanical switch 275 controls the application of power for the operation of the components of indicator module 200 and, indirectly through the use of wireless commands, indicator module 200 is capable of controlling electrical power usage by sensor module 100.

User interface 270 is configured to display information to the user such as the status of indicator module 200, such as the status of sensor module 100, such as proximity information, direction information, and/or other location information for a signaling beacon. User interface 270 may include indicators such as, but not limited to, lights, light emitting diodes, high-brightness light emitting diodes, electronic displays, liquid crystal displays, and other types of optical devices. Optionally, user interface 270 is also configured to receive input information from a user and consequently may include a switch or other information input device such as, but not limited to, buttons, knobs, and touch sensitive screen. Optionally, one or more alarms may be incorporated with user interface 270 for displaying and/or communicating information to the user or indicator module 220 may include separately the one or more alarms 280.

Examples of suitable devices for showing information and/or indicating alarms that can be incorporated in user interface 270 and/or in the one or more alarms 280 include, but are not limited to, devices for generating sound for producing audible representations of information or signals, devices for producing visual representations of the information or signals, and devices for producing mechanical and/or vibration representations of information or signals.

According to one embodiment of the present invention, indicator module 200 includes user interface 270 and/or the one or more alarms 280 comprising one or more devices such as, but not limited to, lights, light emitting diodes, beepers, bells, buzzers, mechanical vibration generators, sirens, speakers, whistles, and other types of sound generators to indicate that sensor module 100 is within a predetermined proximity of a signaling beacon. In one or more embodiments of the present invention, the one or more alarms 280 are controlled so as to provide indications of the proximity of the beacon by changes in the alarm characteristics such as intensity, frequency, and/or amplitude of the alarm signal for alarms that emit sound, alarms having flashing lights, and alarms using mechanical vibration as the distance between the sensor module and the beacon decreases. According to one embodiment, the intensity, frequency, and/or amplitude is inversely proportional to the distance between the sensor module and the beacon. As another option, different alarms and/or different combinations of alarms may be used in relation to the distance between the sensor module and the beacon. Optionally, indicator module 200 may be configured to indicate and/or activate an alarm when sensor module 100 is within a distance such as about one meter from a signaling beacon. Or, indicator module 200 may be configured to indicate and/or activate an alarm when sensor module 100 is within a distance such as about one half meter from a signaling beacon. In another embodiment of the present invention, indicator module 200 is configured so that an alarm is only signaled when sensor module 100 is within a distance of about one half meter from a signaling beacon.

Optionally, first information processor 110 and/or second information processor 220 may be configured to analyze information from RF receiver 120 to identify and eliminate false positive readings for the beacon location. According to one embodiment of the present invention, the elimination of false positives is accomplished by analyzing beacon pulse waveforms and discarding waveforms that do not match one or more characteristics for signals from the beacon. An example of a characteristic that may be used for one or more embodiments of the present invention comprises pulsed signals versus continuous signals. The beacon signals are pulsed. The beacon signals can be distinguished from 457 kHz noise signals that are continuous and the continuous signals are ignored. In other words, according to one or more embodiments of the present invention, the waveforms can be analyzed and confirmed to consist of a sequence of pulses. This could eliminate, for example, a continuous 457 kHz false signal.

For one or more embodiments of the present invention, computer executable instructions enable additional capabilities for sensor module 100 and/or indicator module 200. The computer executable instructions may be stored in the memory of first information processor 110 and/or second information processor 220. According to one embodiment of the present invention, first information processor 110 includes computer executable instructions to produce a sleep mode so as to reduce power consumption from first power supply 150. As an option for some embodiments of the present invention, the sleep mode may be produced periodically. According to another embodiment of the present invention, first information processor 110 comprises computer executable instructions for activating detection of the RF signal from the beacon and derivation of the location information in response to a wirelessly transmitted command from indicator module 200. In another embodiment of the present invention, second information processor 220 comprises computer executable instructions for wirelessly transmitting a command to sensor module 100 to enter a sleep mode so as to reduce power consumption from first power supply 150.

In still another embodiment of the present invention, sensor module 100 comprises computer executable code to produce a sleep mode during which sensor module 100 power utilization is reduced or minimized. Indicator module 200 comprises computer executable code to wirelessly transmit a signal to sensor module 100 to cause sensor module 100 to enter the sleep mode or to awaken from the sleep mode.

According to another embodiment of the present invention, sensor module 100 comprises computer executable code to periodically awaken from a sleep mode to check for instructions from the indicator module. In a further embodiment, the computer executable code causes sensor module 100 to check for instructions more frequently when a signal is detected from a signaling beacon and to check for instructions less frequently when there is no signal detected from a signaling beacon.

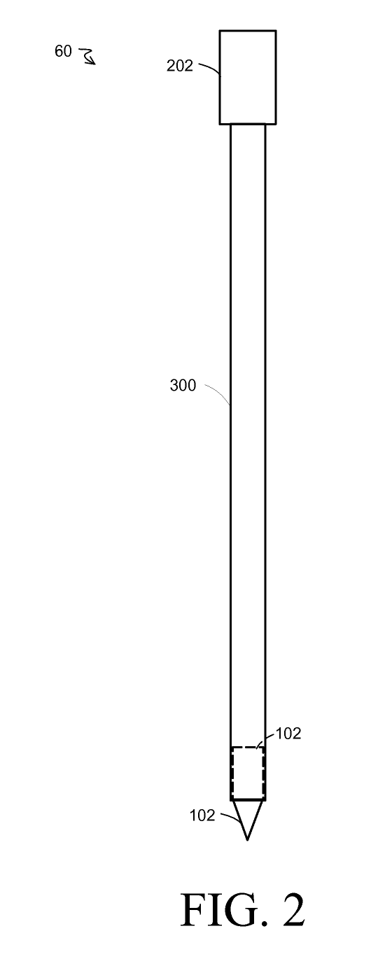

Reference is now made to FIG. 2 where there is shown an apparatus 60 for locating an avalanche victim's beacon. Apparatus 60 comprises a sensor module 102 that is essentially the same as sensor module 100 described for FIG. 1. Sensor module 102 comprises a first information processor, a first wireless transmitter-receiver, a RF receiver, and a first connector for electrical connection with a first electrical power supply substantially as described above for sensor module 100.

Apparatus 60 comprises an indicator module 202 that is essentially the same as indicator module 200 described for FIG. 1. Indicator module 202 comprises a second information processor, a second wireless transmitter-receiver, and a second connector for electrical connection with a second electrical power supply, a user interface, and, optionally, one or more alarms substantially as described above for indicator module 200.

FIG. 2 also shows apparatus 60 comprising a pole 300 having sensor module 102 attached proximate one end and having indicator module 202 detachably attached proximate the opposite end. Sensor module 102 and indicator module 202 are configured so that they are of capable wireless communication for information transfer therebetween. According to one or more embodiments of the present invention, sensor module 102 and indicator module 202 do not have a hard wire connection between them; in other words, they each have independent energy sources and communications between them are by wireless transmission.

The RF receiver in sensor module 102 is responsive to radio frequency waves from the beacon. According to one embodiment of the present invention, the RF receiver comprises an amplitude-modulation receiver circuit configured to detect 457 kHz signals from the beacon. The first wireless transmitter receiver in sensor module 102 and a second wireless transmitter receiver in indicator module 202 are configured for wireless communication using a frequency of about 2.4 GHz. In a further embodiment, sensor module 100 comprises one or more antenna window materials that that are substantially transparent to 457 kHz signals and substantially transparent to 2.4 GHz signals.

In one or more embodiments, pole 300 is configured for probing snow and may have dimensions similar to those to other snow probes. A variety of lengths can be used for pole 300; typical lengths for pole 300 may be in the range of 1 meter to 4 meters. According to one embodiment, pole 300 has an axial bore such as that for a tube. Optionally, the bore may extend substantially from one end to the opposite end of the pole. As another option, pole 300 may be configured so that the length of the pole can be changed such as through a telescoping action for pole segments of differing diameters that fit into each other and/or such as a folding action. A variety of materials may be used for pole 300. Examples of materials suitable for pole 300 include, but are not limited to, aluminum alloy, carbon fiber composite, fiberglass, and other materials suitable for use for snow probes.

One or more embodiments of the present invention have been tested. For one of the test, apparatus 60 comprised sensor module 102 and indicator module 202 configured for wireless communication at 2.4 GHz. Sensor module 102 was receptive to signals from a beacon at 457 kHz. Pole 300 was made of aluminum or aluminum alloy and a section of carbon fiber composite at the sensor module attachment end and had an axial bore. In this experiment, apparatus 60 was used successfully to locate a beacon buried under about 2 meters of snow to within about 0.15 meter of the beacon.

Optionally, sensor module 102 may be detachably connected to pole 300 such as using a threaded connection or a reversible locking connection. According to one or more embodiments of the present invention, sensor module 102 and the end of pole 300 for attachment of sensor module 102 are threaded so as to make a threaded coupling of sensor module 102 and pole 300. Optionally, indicator module 202 is detachably connected to pole 300 using couplings such as, but not limited to, press-fit coupling, threaded coupling, quick release coupling, and reversible locking coupling. In one or more embodiments of the present invention, indicator module 202 further comprises a fastener for attachment of indicator module 202 to pole 300. According to another embodiment of the present invention, indicator module 202 further comprises a fastener for attachment of indicator module 202 to the user or the user's clothing.

According to one embodiment of the present invention, apparatus 60 has the first wireless transmitter-receiver configured so as to be capable of transmitting and receiving information wirelessly at approximately 2.4 GHz and the RF receiver is an amplitude modulated radio receiver configured to receive signals at 457 kHz. According to another embodiment of the present invention, pole 300 has dimensions and/or composition to aid in guiding an approximately 2.4 GHz communication signal from sensor module 102 through snow to be received by indicator module 202.

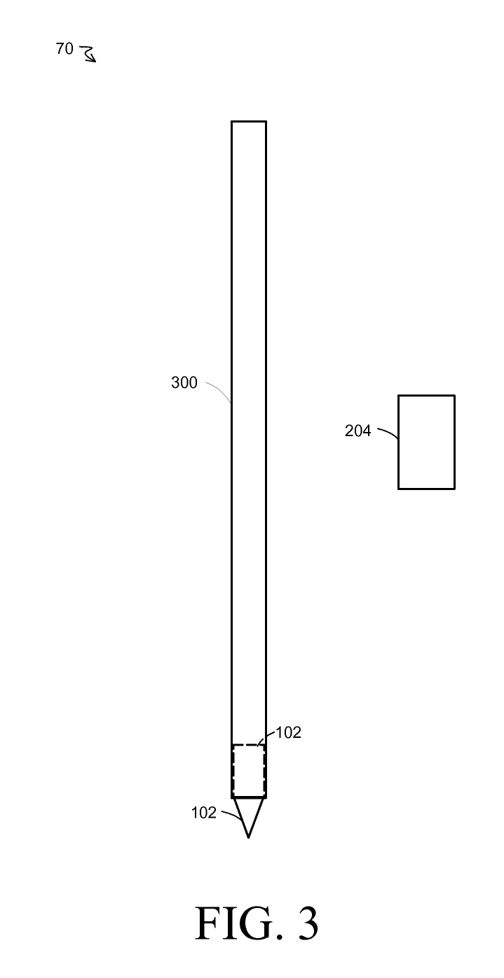

Reference is now made to FIG. 3 where there is shown an apparatus 70 for locating an avalanche victim's beacon according to an embodiment of the present invention. Apparatus 70 is essentially the same as apparatus 60 described above for FIG. 2 with the exception that apparatus 70 has indicator module 204 detached from pole 300. Indicator module 204 is essentially the same as indicator module 202 described for FIG. 2.

According to one embodiment of the present invention, apparatus 70 has the first wireless transmitter-receiver configured so as to be capable of transmitting and receiving information wirelessly at approximately 2.4 GHz and the RF receiver is an amplitude modulated radio receiver configured to receive signals at 457 kHz.

According to another embodiment of the present invention, pole 300 has dimensions and/or composition to aid in guiding an approximately 2.4 GHz communication signal from sensor module 102 through snow to be received by indicator module 204.

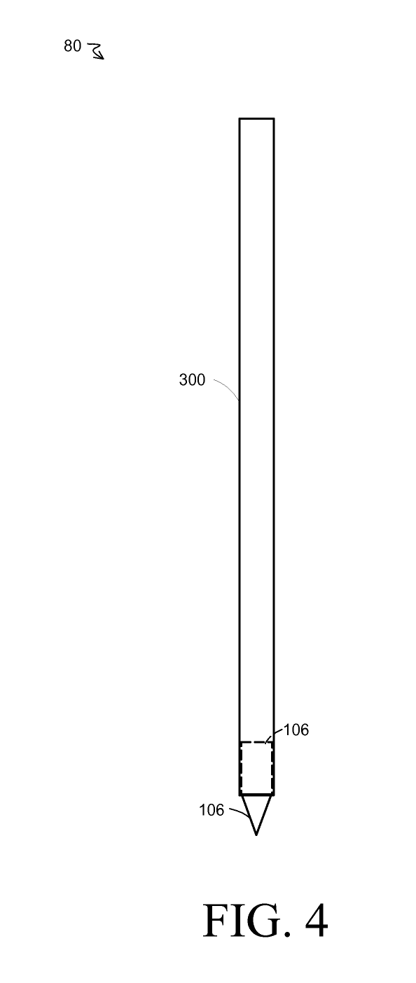

Reference is now made to FIG. 4 where there is shown an apparatus 80 for locating an avalanche victim's beacon according to an embodiment of the present invention. Apparatus 70 is essentially the same as apparatus 60 described above for FIG. 2 with the exception that apparatus 80 has sensor module 106 attached to pole 300 and apparatus 80 does not include an indicator module. Sensor module 106 comprises a first information processor, a first wireless transmitter-receiver, and a RF receiver that is essentially the same as that described above for a sensor module 100. The RF receiver is responsive to radio frequency signals from the beacon. The RF receiver is configured to provide input information to the first information processor. The first information processor is capable of deriving location information for the beacon using the input information from the RF receiver. The first information processor is capable of outputting the location information to the first wireless transmitter-receiver for wireless transmission. Pole 300 has sensor module 106 connected proximate one end of pole 300 for plunging the sensor module into snow.

According to one embodiment of the present invention, apparatus 80 has the first wireless transmitter-receiver configured so as to be capable of transmitting and receiving information wirelessly at approximately 2.4 GHz and the RF receiver is an amplitude modulated radio receiver configured to receive signals at 457 kHz. According to another embodiment of the present invention pole 300 has dimensions and/or composition to aid in aid in guiding an approximately 2.4 GHz communication signal from the sensor module through snow.

Another aspect of the present invention is a method of searching for a radio frequency signal emitting beacon buried in snow. According to one embodiment, the method comprises providing a pole having a sensor module attached proximate to one end and providing an indicator module. The method also comprises plunging the end of the pole having the sensor module into the snow and detecting the radio frequency signal with the sensor module. Further the method comprises, determining proximity information and/or direction information for the location of the beacon using the sensor module. The method comprises transmitting the proximity information and/or the direction information wirelessly using the sensor module and receiving the wirelessly transmitted proximity information and/or the direction information from the sensor module using the indicator module. The method also comprises producing audible, visual, and/or vibrational representations of the proximity information and/or the direction information using the indicator module. Optionally, the intensity, frequency, and/or amplitude of the audible signal, mechanical signal (vibration), and/or visible signal is generated to be inversely proportional to the distance between the sensor module and the beacon. Alternatively, the sensor module may transmit information about the radio frequency signal to the indicator module so that the indicator module is used to determine proximity information and/or direction information for the location of the beacon. One or more of the steps may be repeated as needed to locate the beacon.

Optionally, the transmitting the proximity information and/or the direction information wirelessly using the sensor module and the receiving the wirelessly transmitted proximity information and/or the direction information from the sensor module using the indicator module are accomplished using a communication frequency of about 2.4 GHz. According to one or more embodiments of the present invention, the determining the proximity information comprises de-tuning the sensitivity of the sensor module to the radio frequency signal. Optionally, the de-tuning the sensitivity of the sensor module to the radio frequency signal is accomplished so that the sensor module is only sensitive to beacons within a small distance from the sensor module. One or more embodiments of the present invention are de-tuned so as to only be sensitive enough to detect beacons that are within a distance of about a meter from the sensor module.

As another option for one or more embodiments of the present invention, the method comprises using the indicator module to wirelessly transmit a command to the sensor module to begin detecting the radio frequency signal. In another embodiment of the present invention the method comprises having the sensor module check for commands and/or instructions from the indicator module. Embodiments of the present invention may further comprise generating an audible signal, mechanical signal such as vibration, and/or visible signal when the beacon is detected to be within a predetermined range such as 0 to 1 meter.

According to another embodiment, the apparatus is capable of operating and is used with the indicator module detached from the pole.

In the foregoing specification, the invention has been described with reference to specific embodiments. However, one of ordinary skill in the art appreciates that various modifications and changes can be made without departing from the scope of the present invention. Accordingly, the specification is to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. In combination:
a sensor module comprising a first information processor, a first wireless transmitter-receiver, a RF receiver, and a first electrical power supply or power supply connector for applying power to the sensor module; and
an indicator module comprising one or more alarms, a user interface, a second information processor, a second wireless transmitter-receiver, and a second electrical power supply or power supply connector for applying power to the indicator module; wherein:
a) the RF receiver is responsive to radio frequency signals from a beacon and is capable of providing input information to the first information processor, the first information processor is capable of receiving input information from the RF receiver and deriving location information and/or direction information for the beacon using the input information from the RF receiver, the first information processor is capable of outputting the location information to the first wireless transmitter-receiver for wireless transmission to the second wireless transmitter-receiver, the second wireless transmitter-receiver is capable of outputting the wirelessly transmitted location information and/or direction information to the second information processor, the second information processor is capable of providing the location information and/or direction information for the beacon to the one or more alarms and/or the user interface; or
b). the RF receiver is responsive to radio frequency signals from a beacon and is capable of providing input information to the first information processor, the first information processor is capable of outputting the information to the first wireless transmitter-receiver for wireless transmission to the second wireless transmitter receiver, the second wireless transmitter-receiver is capable of outputting the wirelessly transmitted information to the second information processor, the second information processor is capable of deriving location information and/or direction information for the beacon using the modified information for the signals from the beacon, the second information processor is capable of providing the location information and/or direction information for the beacon to the one or more alarms and/or the user interface.

2. The combination of claim 1, further comprising a pole, the pole having the sensor module connected proximate one end of the pole.

3. The combination of claim 1, wherein the first wireless transmitter-receiver comprises one or more antennas.

4. The combination of claim 1, wherein the RF receiver comprises a ferrite bar antenna.

5. The combination of claim 1, wherein the RF receiver comprises an amplitude-modulation receiver circuit to detect the signals from the beacon.

6. The combination of claim 1, wherein the first information processor includes computer executable instructions to produce a sleep mode periodically so as to reduce power consumption from the first electrical power supply or power supply connector.

7. The combination of claim 1, wherein the first information processor includes computer executable instructions for activating detection of the RF signal from the beacon and derivation of the location information in response to a wirelessly transmitted command from the indicator module.

8. The combination of claim 1, wherein the second information processor includes computer executable instructions for wirelessly transmitting a command to the sensor module to enter a sleep mode so as to reduce power consumption from the first electrical power supply or power supply connector.

9. An apparatus for locating an avalanche victim's beacon, the apparatus comprising:
a sensor module comprising a first information processor, a first wireless transmitter-receiver, a RF receiver, and a first connector for electrical connection with a first electrical power supply;
an indicator module comprising one or more alarms, a user interface, a second information processor, a second wireless transmitter-receiver, and a second connector for electrical connection with a second electrical power supply; and
a pole having the sensor module attached proximate one end and having the indicator module detachably attached proximate the opposite end;
the sensor module and the indicator module being capable of wireless communication for information transfer therebetween.

10. The apparatus of claim 9, wherein the RF receiver is responsive to radio frequency waves from the beacon.

11. The apparatus of claim 9, wherein the RF receiver comprises an amplitude-modulation receiver circuit to detect 457 kHz signals from the beacon.

12. The apparatus of claim 9, wherein the first wireless transmitter-receiver and the second wireless transmitter-receiver communicate using a frequency of about 2.4 GHz.

13. The apparatus of claim 9, wherein the sensor module comprises one or more antenna window materials that that are substantially transparent to 457 kHz signals and substantially transparent to 2.4 GHz signals.

14. The apparatus of claim 9, wherein power for the sensor module is controlled by signals wirelessly transmitted from the indicator module.

15. The apparatus of claim 9, wherein the sensor module has computer executable code to produce a sleep mode during which the sensor module power utilization is reduced or minimized.

16. The apparatus of claim 9, wherein the sensor module has computer executable code to produce a sleep mode during which the sensor module power utilization is reduced or minimized and the indicator module includes computer executable code to wirelessly transmit a signal to the sensor module to cause the sensor module to enter the sleep mode or to awaken from the sleep mode.

17. The apparatus of claim 9, wherein the sensor module has computer executable code to periodically awaken from a sleep mode to check for instructions from the indicator module.

18. The apparatus of claim 9, wherein the sensor module has computer executable code to derive proximity information and/or direction information for a beacon by using radio frequency waves emitted by the beacon received by the RF receiver; the sensor module is capable of wirelessly transmitting the proximity information and/or direction information to the indicator module.

19. The apparatus of claim 9, wherein the indicator module further comprises a mechanical switch to start or to terminate reduced power consumption conditions.

20. The apparatus of claim 9, wherein the sensor module has a threaded coupling to the pole.

21. The apparatus of claim 9, wherein the indicator module further comprises a fastener for attachment of the indicator module to the pole.

22. The apparatus of claim 9, wherein the indicator module further comprises a fastener for attachment of the indicator module to the user or the user's clothing.

23. A method of searching for a radio frequency signal emitting beacon buried in snow, the method comprising:
providing a pole having a sensor module attached proximate to one end;
providing an indicator module;
plunging the end of the pole having the sensor module into the snow;
detecting the radio frequency signal with the sensor module;
determining proximity information and/or direction information for the location of the beacon using the sensor module;
transmitting the proximity information and/or the direction information wirelessly using the sensor module;
receiving the wirelessly transmitted proximity information and/or the direction information from the sensor module using the indicator module; and
producing audible, visual, and/or vibrational representations of the proximity information and/or the direction information using the indicator module.

24. The method of claim 23, wherein the transmitting the proximity information and/or the direction information wirelessly using the sensor module and the receiving the wirelessly transmitted proximity information and/or the direction information from the sensor module using the indicator module are accomplished using a communication frequency of about 2.4 GHz.

25. The method of claim 23, further comprising using the indicator module to wirelessly transmit a command to the sensor module to begin detecting the radio frequency signal.

26. The method of claim 23, further comprising having the sensor module check for instructions from the indicator module.

27. The method of claim 23, further comprising generating an audible signal, mechanical signal (vibration), and/or visible signal when the beacon is detected to be within a predetermined range.

28. The method of claim 27, wherein the intensity, frequency, and/or amplitude of the audible signal, mechanical signal (vibration), and/or visible signal is generated to be inversely proportional to the distance between the sensor module and the beacon.

29. An apparatus for wirelessly transmitting information to an indicator module for locating a beacon for a snow avalanche victim, the apparatus comprising:
a sensor module comprising a first information processor, a first wireless transmitter-receiver, and a RF receiver; the RF receiver being responsive to radio frequency signals from the beacon and being capable of providing input information to the first information processor, the first information processor being capable of deriving location information for the beacon using the input information from the RF receiver, the first information processor being capable of outputting the location information to the first wireless transmitter-receiver for wireless transmission; and
a pole having the sensor module connected proximate one end for plunging the sensor module into snow.

30. The apparatus of claim 29, wherein the first wireless transmitter-receiver is capable of transmitting and receiving at approximately 2.4 GHz.

31. The apparatus of claim 29, wherein the pole has dimensions and/or composition to aid in guiding an approximately 2.4 GHz communication signal through snow from the sensor module.
